(19) United States
(12) Patent Application Publication
(10) Pub. No.: US 2005/0052762 A1
(43) Pub. Date: Mar. 10, 2005

(54) Method and apparatus for safely backing a vehicle into a traffic lane

(76) Inventor: Salim Ejaz, Muttontown, NY (US)

Correspondence Address: ALFRED M. WALKER, 225 OLD COUNTRY ROAD, MELVILLE, NY, 11747-2712, US

(21) Appl. No.: 10/658,354

(22) Filed: Sep. 9, 2003

(51) Int. Cl. G02B 5/08; G02B 7/18; G02B 7/182

(52) U.S. Cl. 359/871; 359/838

(57) ABSTRACT

A visual aid helping a driver to safely back into a traffic lane from a parking place, said visual aid providing visual images from a vantage point just beyond the rear periphery of a motor vehicle, wherein the visual information shows vehicular and/or pedestrian traffic in close proximity to rear of the motor vehicle and obliquely to left and right sides thereof, said visual images being presented within the view of the driver.

### FIELD OF THE INVENTION

The present invention relates to safety viewing devices for motor vehicles.

### BACKGROUND OF THE INVENTION

Among related prior art includes U.S. Pat. No. 4,758,078 of Bracamonte, which describes an upwardly extendable motor vehicle mirror used to view beyond visually obstructive vehicles, such as SUVs and vans.

However, in Bracamonte '078, the driver can only see far away. There is a blind spot in the area directly beside the rear of an SUV or van, such as where a small child or shopping cart or other obstruction such as a closely passing vehicle might be located.

In contrast, there is a need for a rearview mirror, which is rearwardly extendable from the rear light area, clearly exposing anything immediately behind the adjacent SUV or van, which is a feature not attainable with the upwardly extending mirror of Bracamonte '078.

### OBJECTS OF THE INVENTION

It is therefore an object of the present invention to provide a view to the motor vehicle driver of conditions in both directions along the traffic lane in addition to the area directly behind the vehicle, which is normally visible.

It is also an object of the present invention to provide a visual aid which helps a driver to safely back into a traffic lane from a parking place, wherein the visual images are derived from a vantage point just beyond the rear periphery of the vehicle.

It is also an object of the present invention to provide a visual aid which clearly shows vehicular or pedestrian traffic in close proximity to a danger zone in the vicinity of a motor vehicle and beyond

It is further an object of the present invention to provide a visual aid for providing a rear view which is also visible in the reflection from the rear view mirror.

Other objects will become apparent from the following description of the present invention.

### SUMMARY OF THE INVENTION

In keeping with the aforementioned objects and others which may become apparent, the present invention provides a view to the driver of conditions in both directions along the traffic lane in addition to the area directly behind the vehicle which is normally visible. This visual aid helps a driver to safely back into a traffic lane from a parking place. The visual images are derived from a vantage point just beyond the rear periphery of the vehicle. This visual information, which clearly shows vehicular or pedestrian traffic in close proximity to the danger zone and beyond, is presented within the normal viewscape of a driver turned around and peering through the rear vehicle window as he or she prepares to back out. The visual image presented is also visible in the reflection from the rear view mirror. For some impaired drivers with limited range of motion of their torso, this is the only rear viewscape they have while backing up. This is becoming a more prevalent condition as the driving population ages. The visual aids of this invention are of particular benefit to low vehicles obscured on both sides by high vehicles (such as trucks, sport utility vehicles (SUV's), or vans) parked alongside.

While the invention can be built into a motor vehicle, the preferred embodiment of this invention is designed to be easily installed as an aftermarket accessory. It is attached to the rear license plate holder and has its own primary batteries as a power supply within a compact housing that also contains a mechanism and controls to deploy or store a mirror upon radio command from a small transmitter within the passenger compartment of the vehicle. The mirror has two slightly concave reflecting surfaces placed at right angles to each other and attached to the end of a telescoping rod such as to place the mirror such that it can be easily seen by the driver through the rear window when deployed. The reflections from the mirror surfaces are oriented so that views of the traffic lane in both directions are provided simultaneously. The vehicle should be slowly backed out just parallel or slightly beyond the longest vehicle parked alongside to gain maximum advantage from the view provided prior to backing out completely into the traffic lane. In two related variations of this embodiment, the primary batteries are replaced with rechargeable batteries in one version. They are charged intermittently every time the brake lights are operated by tapping into the brake light lines which are normally available at the rear of the vehicle. In another variation, the radio communications is replaced by a slender fiber optic cable which is snaked into the passenger compartment from the rear housing through a trunk or window and discreetly routed to the driver's area to terminate in a simple control box containing a light emitting diode (LED), battery and push button switch.

In another similar embodiment also attached to the rear license plate holder, the telescoping mirror is deployed vertically and a single mirror surface is used. In this case, the entire deployment mirror assembly is rotatable by a second motor so as to orient the mirror to view first one direction and then the other direction along the traffic lane.

For vehicles that have a robust car top carrier attached, a simpler embodiment is provided. A two surface mirror is attached at the end of an extending arm that is attached in a fixed fashion to the car top carrier. While perhaps not aesthetically pleasing, it is a simple inexpensive solution that is compatible with many SUV's, station wagons, or small commercial delivery vehicles.

For inclusion as a factory-provided accessory on new vehicles, a deployable embodiment of this invention can be totally hidden in the rear roof structure (until used) or can be stored in a streamlined bulge in the roof structure. The mirror, which is now hinged so that both surfaces can be stored flat, is pushed out of the roof on a telescoping rod and hinged down on a short arm to deploy in clear view of the rear window.

Another embodiment that is designed for simple aftermarket installation attaches the mirror accessory to the rear window opposite the driver side. This will work on most sedans, station wagons and SUV's. The accessory actually straddles the glass on the rear window with the folded two-surface deployable mirror in a flat housing on the outside while the drive motor and control relays are on the inside of the window. The window is moved up to seal the opening with gaskets provided to prevent wind noise or infiltration. For deployment, the mirror is extended rearward from the open end of the flat housing, and then at the end of the stroke a short arm positions it in view of the rear window. Since there is ready communication with the vehicle interior with this embodiment, it is easily powered by plugging into the cigarette lighter outlet and is controlled via hard wire with a simple two pushbutton control pod.

A final embodiment, with variations, uses a two-camera closed circuit video system with a flat panel display screen configured as a split screen. The display pops down from the ceiling at the rear window when needed and folds flat with the ceiling when not in use. The cameras can be mounted in a fixed position on brackets on the rear bumper facing sideways in opposite directions. For inclusion as original equipment on a new vehicle, the two cameras are attached to an arm which deploys out of a covered hatch in the trunk lid upon command.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a Top view of parked vehicles with approaching traffic using a visual aid of this invention.

FIG. 2 is a Perspective view of a two-surface mirror of this invention.

FIG. 3 is a Rear view of vehicle with deployed mirror of the preferred embodiment of this invention.

FIG. 4 is a Perspective view of internal major components of the preferred embodiment.

FIG. 5 is a Block diagram of the preferred embodiment of this invention.

FIG. 6 is a Side view of an alternate embodiment of this invention using a mirror with one reflecting surface.

FIG. 7 is a Side view of a van with a fixed mirror embodiment of this invention.

FIG. 8 is a Rear view of van with fixed mirror embodiment.

FIG. 9 is a Rear view of vehicle with roof mounted embodiment of this invention in stored position.

FIG. 10 is a Side view of vehicle with roof mounted embodiment in deployed position.

FIG. 11 is a Side view of vehicle with rear window mounted embodiment of this invention showing both stored and deployed positions.

FIG. 12 is a Rear view of vehicle with rear window mounted embodiment in deployed position.

FIG. 13 is a Schematic diagram of rear window mounted embodiment showing use of two automotive relays for control.

FIG. 14 is a Top view of two-camera arm assembly used with video system embodiment of this invention.

FIG. 15 is a Side view of vehicle rear quarter illustrating deployment of camera arm from hatch in trunk lid as used in video system embodiment.

FIG. 16 is a Interior rear view of vehicle equipped with video system embodiment of this invention.

### DETAILED DESCRIPTION OF THE INVENTION

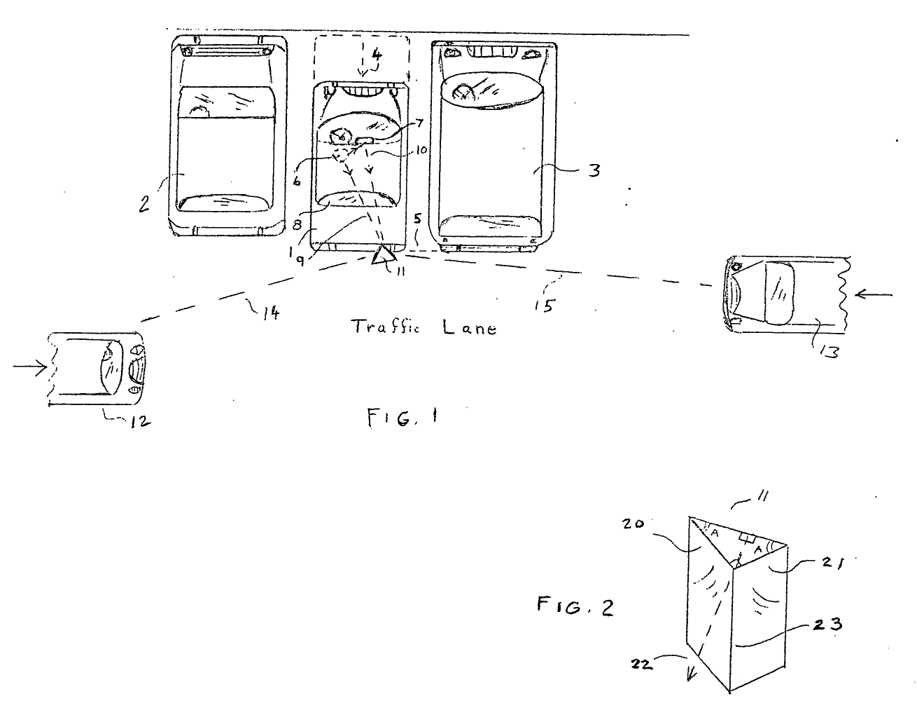

FIG. 1 shows the overall geometry of a car equipped with the display feature of this invention in a “helicopter” type of view. Vehicle 1 is attempting to back out of a parking space between SUV 2 and van 3. A two-surface mirror 11 (shown more clearly in FIG. 2) is positioned in direct view of driver 6 via view line 9 or in a reflected view from rear view mirror 7 via view line 10. Vehicle 1 is backed up part way by distance 4 so as to roughly line up 5 with the longer adjacent vehicle 3. Approaching vehicle 13 via image ray 15 is viewable on one side of mirror 11 through rear window 8. Simultaneously, approaching vehicle 12 is visible as an image the other side of mirror 11 via image ray 14. Neither of these approaching vehicles would be visible to driver 6 except for the images presented by mirror 11 due to his restricted view of the traffic lane through all vehicle windows in this position.

The two-surface mirror of FIG. 2 has two reflecting surfaces, 20 and 21, which are preferably slightly concave so as to intercept a wider view (similar in concept to the side view mirror distal to the driver). Surfaces 20 and 21 are preferably at right angles to each other with the sighting line 22 permitting a simultaneous view of both surfaces. For some embodiments, mirror 11 is designed with a hinge 23 joining surfaces 20 and 21 with spring bias from a torsion spring (not shown) to place the surfaces at right angles to each other. A light force inward at hinge 23 will permit mirror surfaces 20 and 21 to flatten out into a planar configuration.

The two adjacent mirror surfaces 20 and 21 form an angle ranging from greater than 0 degrees up to about 120 degrees, such as between 45 and 90 degrees, preferably 90 degrees, and a connecting means of connecting the mirror surfaces 20 and 21.

The preferred embodiment of this invention is designed as an easily installed aftermarket accessory which is stored in a protective housing when not deployed.

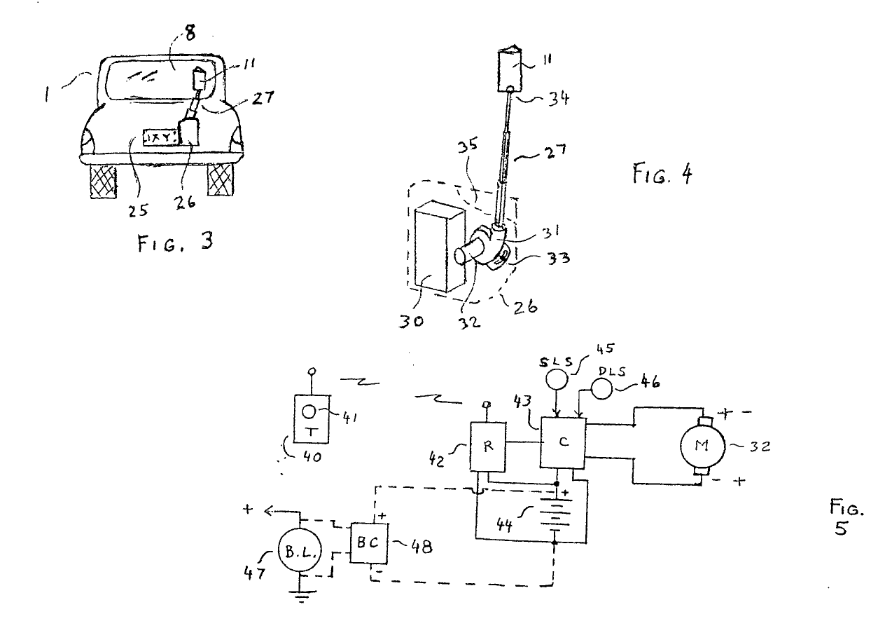

Therefore, FIG. 3 shows a view at the rear vehicle 1 in the deployed position with telescoping rods 27 supporting mirror 11 in proper orientation visible through rear window 8.

FIG. 4 shows an outline of housing 26 with self opening and closing lips 35 through which mirror 11 is driven by telescoping rod assembly 27. The telescoping rod 27 is of non-circular crossection so as to resist twisting and have the ability to maintain rotational registration. It is driven in similar fashion to automotive power antennas via an internal semi-rigid cable which is urged into and out of housing 31 by a actuator or motor, such as a reversible DC permanent magnet gearmotor 32. While it may be installed at any rearward location, such as in the fender or rear trunk cover, in a preferred embodiment, housing 26 is attached to a bracket that fits under license plate 25 and shares the same mounting screws. Housing 31 is angle adjustable at bracket 33 and mirror mount 34 is a ball joint that places mirror 11 in a vertical position at the correct view line before clamping. Position sensors are adjustable to customize the deployed and stored positions for a particular installation. These can be actual mechanical limit switches or optical or magnetic sensors. Inner housing 30 contains batteries and radio receiver and control equipment.

The block diagram of FIG. 5 illustrates the operation of the embodiment of FIG. 4. A small transmitter 40 similar to a garage door opener is used by the driver to toggle between deploy and store modes by pressing push button 41. Receiver 42 through control block 43 operates gearmotor 32 with the proper polarity to accomplish the desired move. Deployed limit sensor 46 stops motor 32 when at the proper level. Stored limit sensor 45 stops motor 32 when mirror 11 is properly stored. Batteries 44 can be 3 or 4 alkaline batteries such as “C” size. Such use would simplify installation, but it adds the need to change depleted batteries. This can be eliminated at the expense of a slightly more involved installation by using rechargeable batteries such as NiCad or LiMH types which are charged by charger 48 intermittently every time brake light 47 is actuated. Another simplification substitutes a single optical fiber connecting an internal controller consisting of a pushbutton, battery, and LED to controller 43 directly. While eliminating the radio frequency link, it makes the installation more cumbersome by requiring routing a tiny optical fiber from the outside of the vehicle to the interior.

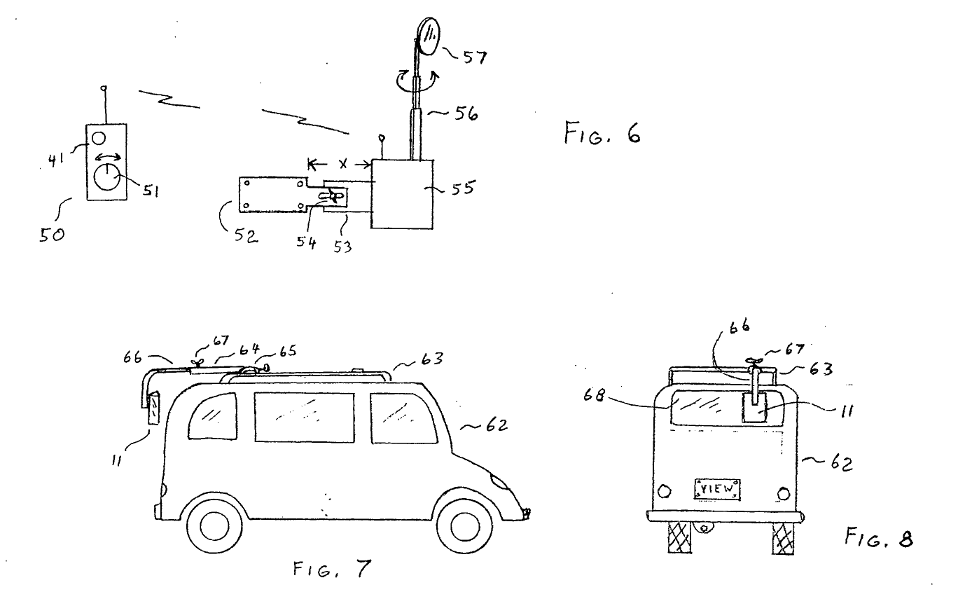

FIG. 6 shows an embodiment similar to the preferred embodiment but using a single reflecting surface mirror 57. Housing 55 is attached to horizontal adjuster link 53 with clamp 54. While the assembly can be attached anywhere to a rear fender or to a trunk cover, preferably the assembly attaches to the license plate holder via plate 52. Telescoping assembly 56 must be set in a vertical position for this embodiment. Internally, an actuator or motor, such as a second gearmotor, is used to rotate the entire vertical positioning assembly to orient mirror 57 first in one position along the traffic lane and then in the second position in the opposite direction. Transmitter controller 50 has now been enhanced with two position rotary control 51 to control rotation, in addition to push button 41 to control up and down operations.

FIGS. 7 and 8 illustrate an embodiment of this invention on vehicle 62 wherein mirror 11 is in a fixed deployed position. It is simply clamped to a rigid vehicle cartop carrier 63 via clamp 65. It is then adjusted by sliding out bent member 66 out of fixed member 64 to the desired position and clamping via thumbscrew 67.

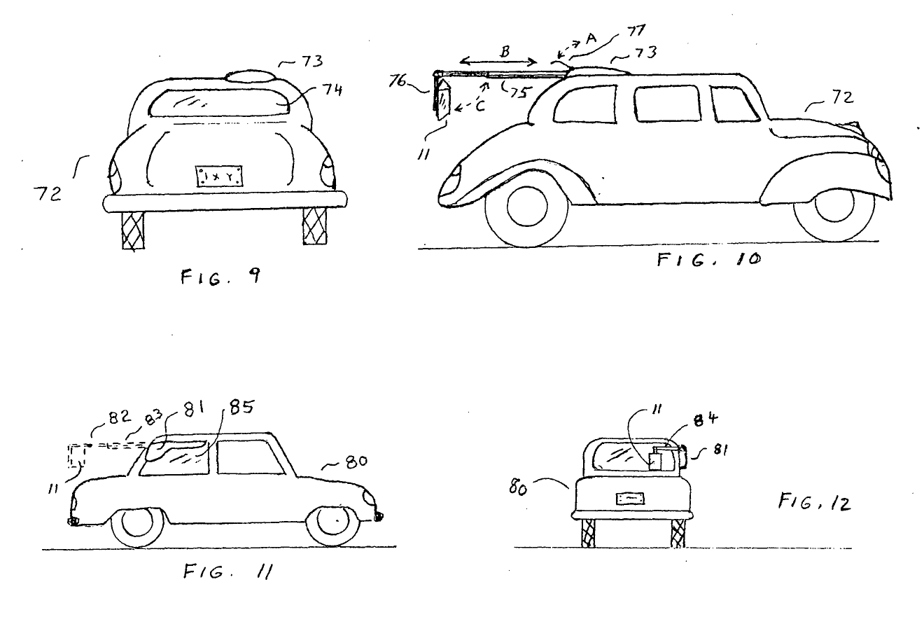

FIGS. 9 and 10 illustrate an embodiment of this invention as original equipment.

FIG. 9 shows vehicle 72 with rear window 74 and roof mounted streamlined pod 73 housing a stored mirror assembly.

FIG. 10, the side view, shows the mirror 11 deployed at the end of telescoping rod 75 and short arm 76 after emerging from pod 73 through door 77. In actuality, streamlined pod 73 can be eliminated with the entire accessory stored within the normal exterior roofline with the option of a slight bulge on the interior roofline. When deployed, door 77 is powered open (arc “A”) and telescoping members 75 are urged forward (distance “B”) wherein at the limit of movement, arm 76 swings down (“C”) thereby placing mirror at the ideal position for viewing through rear window 74. The reverse operations are used to store the feature in its roofline storage compartment. Mirror 11 has the collapsible feature to fit more easily in a flat compartment.

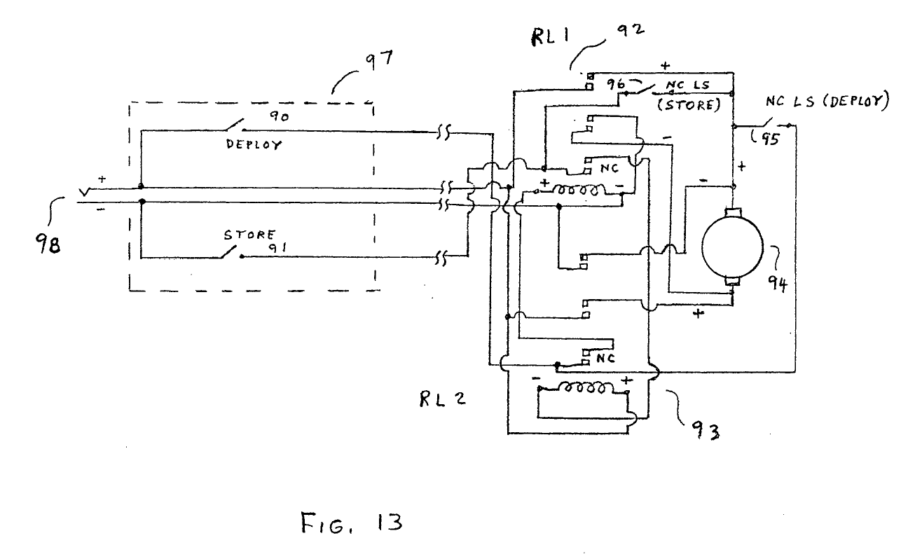

FIGS. 11-13 describe an aftermarket deployable mirror embodiment which is very simple to install with no tools. This system is simply straddled over the glass edge of a side rear window, adjusted for horizontal orientation, and sealed with flexible gaskets.

FIG. 11 shows a side view of vehicle 80 with mirror system in housing 81 which is attached to rear side window 85. When deployed, see dashed lines, telescoping rod 83 is driven out by an outwardly extendable member, such as a telescoping member or a perforated semi-rigid plastic tape, wherein a short horizontal arm 84 (as in FIG. 12) pivoted at 82 deploys to place mirror 11 within view through rear vehicle window. Since housing 81 is flat to conform to the side of vehicle 80, mirror 11 preferably has the collapsible feature.

While other power sources, such as batteries, may be used, the schematic diagram of FIG. 13 shows how power is preferably derived by plugging plug 98 into the vehicle accessory (cigarette lighter) socket. A front mounted control pod 97 may be a switch mechanism, such as simply two momentary single pole normally open switches, one to initiate “deploy” 90 and a second to initiate “store” 91. Using no electronics or microprocessors, two automotive type relays mounted at the rear side window unit are all that is necessary for control. Each of the relays 92 and 93 preferably has three contacts; two are motor drive contacts and are normally open types, while the third set of contacts are normally closed and are used as safety contacts to prevent a short circuit situation if a “store” button 91 is accidentally hit while the deploy process in operation (or vice versa). This circuit latches the relays at the start of the deploy or start process so that a short press of a button is all that is needed to start a process which will stop itself when the appropriate normally closed limit switch is operated. Limit switch 95 stops the deploy process, while limit switch 96 stops the store process. A motor is used, such as gear motor 94, which is preferably a permanent magnet reversible DC motor.

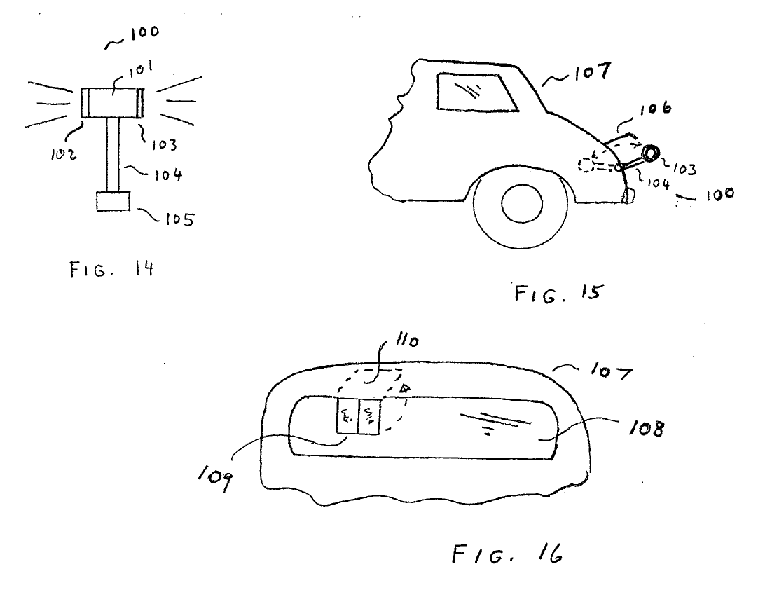

FIGS. 14 through 16 describe an alternate closed circuit video display embodiment using two video cameras and a flat panel display configured as a split screen with the image form each camera providing image for half the screen. Versions of this embodiment for use as an aftermarket installation would use fixed cameras attached to the rear bumper and aimed about 180 degrees away from each other (to the sides of the vehicle) to capture a view of the traffic lane in either direction.

FIGS. 14 and 15 relate to dual camera assembly 100 intended for use as original equipment. Arm 104 is pivoted from a powered pivot 105 and terminates in camera head 101 with video cameras 102 and 103 aimed away from each other.

FIG. 15 shows a portion of vehicle 107 with a hatch lid 106 incorporated in its trunk lid. Camera assembly 100 is pivoted inside of the trunk lid so that it can be deployed out by swinging on power pivot 105 upon command. Hatch lid 106 is powered open prior to deployment. It can be appreciated that cameras 102 and 103 would have a good view of the traffic lane in both directions in the deployed position.

Simultaneously with the deployment of the cameras, flat display 109 flips down from its storage position 110 (as in FIG. 16) flush with the ceiling of the vehicle interior. Note that display 109 in the deployed position is within the viewscape of rear window 108; its image is also viewable as reflected in the rear view mirror.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

1. An apparatus for increasing driver visibility, comprising at least one mirror surface in substantially vertical orientation and extending substantially horizontally from the rear end of a vehicle.

2. The apparatus for increasing driver visibility according to claim 1, further comprising two adjacent mirror surfaces forming an angle ranging between 0 degrees and 120 degrees, and a means of connecting said mirrors.

3. The apparatus for increasing driver visibility according to claim 2, wherein said mirror surfaces form an angle of about 90 degrees.

4. The apparatus for increasing driver visibility according to claim 2, wherein said mirror surfaces are concave.

5. The apparatus for increasing driver visibility according to claim 1 further comprising a means of rotatably altering the positions of said at least one mirror surface.

6. The apparatus for increasing driver visibility according to claim 2, wherein said means of connecting said mirror surfaces comprises a hinge, and further comprising a means of rotatably altering the positions of said mirror surfaces.

7. The apparatus for increasing driver visibility according to claim 6, wherein said mirror surfaces rotatably fold into a substantially planar position for deployment.

8. The apparatus for increasing driver visibility according to claim 1, further comprising a housing for storage of said mirror surface, and a telescoping means for extending said mirror surfaces from said housing.

9. The apparatus for increasing driver visibility as in claim 1, wherein said apparatus is mounted to a rear license plate of the vehicle.

10. A visual aid helping a driver to safely back into a traffic lane from a parking place, said visual aid providing visual images from a vantage point just beyond the rear periphery of a motor vehicle, wherein the visual information shows vehicular and/or pedestrian traffic in close proximity to rear of the motor vehicle and obliquely to left and right sides thereof, said visual images being presented within the view of the driver, said visual aid comprising:
a mirror assembly attached to the motor vehicle, said mirror assembly including a power source within a compact housing containing a lifting mechanism alternately deploying and storing a mirror upon an activator within the passenger compartment of the vehicle.

11. The visual aid as in claim 10 wherein said mirror has a pair of concave reflecting surfaces placed at an angles to each other, said mirror being attached to an end of a telescoping rod deploying said mirror outward.

12. The visual aid as in claim 10 wherein said activator is a radio transmitter.

13. The visual aid as in claim 10 wherein said activator is connected by a communications cable joining said mirror to the passenger compartment of the motor vehicle.

14. The visual aid as in claim 10 wherein said visual aid is attached to a rear license plate holder of the motor vehicle.

15. The visual aid as in claim 14 wherein said telescoping mirror is deployed vertically and a single mirror surface is used, said mirror assembly being rotatable to orient said mirror to view first one direction and then the other direction along a traffic lane.

16. The visual aid as in claim 10 wherein said mirror is a two surface mirror attached at an end of an extending arm attached in a fixed fashion to the car top carrier.

17. The visual aid as in claim 10 wherein said mirror assembly is deployable from within a rear roof structure, said mirror being hinged so that both surfaces can be stored flat, said mirror being deployed out of the roof on a telescoping rod and hinged down on a short arm to deploy in clear view of a rear window of the motor vehicle.

18. The visual aid as in claim 10 wherein said mirror assembly straddles the glass on the rear window of the motor vehicle said folded two-surface deployable mirror, said mirror being extended rearward.

19. The visual aid as in claim 10 wherein said mirror is a two-camera closed circuit video system with a flat panel display screen configured as a split screen, said display deployed down from the ceiling of the motor vehicle at the rear window when needed and folding flat with the ceiling when not in use.

20. A method for safely backing a vehicle into a traffic lane comprising the steps of:
providing a visual display within the viewscape of the driver while peering directly through the rear window or while facing forward;
viewing the rear view mirror wherein said display presents images of said traffic lane in both directions derived from a vantage point just beyond the rear periphery of said vehicle to alert said driver to any approaching traffic which may present a hazard.
